(19) United States
(12) Patent Application Publication
(10) Pub. No.: US 2009/0294733 A1
(43) Pub. Date: Dec. 3, 2009

(54) Process for improved electrospinning using a conductive web

(76) Inventors: Kelly Dean Branham, Woodstock, GA (US); David L. Myers, Cumming, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 12/154,997

(22) Filed: May 29, 2008

(51) Int. Cl. H01B 1/12; B29C 47/00

(52) U.S. Cl. 252/500; 264/465

(57) ABSTRACT

A process for producing a composite conductive fibrous material is provided which includes the steps of providing a conductive fibrous web and supporting the conductive fibrous web with a nonconductive support member. A polymer stream is provided and a voltage is established between the conductive fibrous web and the polymer stream. In this manner, the polymer stream is attracted to the conductive web. Nanofibers are produced by the polymer stream and collected on the conductive web.

### BACKGROUND OF THE INVENTION

There are many advantages to utilizing very fine fibers, such as nanofibers, in a myriad of applications. Nanofibers with huge surface-to-volume ratios have many potential applications in fields such as protective garments, filtration, sensors, drug delivery systems and medical applications. While different processes are able to manufacture nanofibers, one readily available process is electrospinning.

Electrospinning refers to a technology which produces fibers from a polymer solution or polymer melt using interactions between fluid dynamics, electrically charged surfaces and electrically charged liquids. In general, a typical electrospinning apparatus useful for spinning nanofibers from a polymer solution includes a spinneret such as a metallic needle, a syringe and syringe pump, a high-voltage power supply, and a metal collector which is grounded. The polymer solution, which typically includes polymer and a solvent, has been loaded into the syringe and is driven to the needle tip by the syringe pump so that a droplet is formed at the needle tip. An electrode such as a stainless steel wire may be positioned within the syringe and may be used to charge the polymer solution. When the polymer solution within the syringe is charged, the droplet is drawn toward the grounded collector and stretched into a configuration commonly known as a Taylor cone. As the jet of solution flows from the needle tip to the grounded collector, the jet is stretched and the solvent in the polymer solution evaporates. As the jet of solution approaches the grounded collector, the electrical forces cause a whipping affect which results in the nanofibers being spread out onto the collector. A material, such as a nonwoven web, may be positioned between the collector and the tip of the needle to collect the nanofibers.

Many publications are available which describe fully the electrospinning process and its controlling variables, such as, for example, solution viscosity, the distance between the spinneret tip and the collector, voltage and solution conductivity.

Although the electrospinning process described above can produce nanofibers repeatedly, some aspects of the process are undesirable. For example, the nanofibers can be difficult to separate from the collector. Additionally, it is important to appropriately manage the electrical charges which impact the polymer jet to obtain optimum fiber formation. While nonconductive textile webs have been used to collect the nanofibers and eliminate the issues relating to separating the nanofibers from the grounded collector, the dielectric nature of the textile webs can interfere with the stability of the polymer jet and negatively impact fiber formation. A solution is desired which addresses these as well as other issues.

### SUMMARY OF THE INVENTION

In accordance with one embodiment of the present invention, a process for producing a composite conductive fibrous material is disclosed. The process generally includes the steps of providing a conductive fibrous web and supporting the conductive fibrous web with a nonconductive support member. A voltage is established between the conductive fibrous web and a polymer stream so that the polymer stream is attracted to the conductive fibrous web. Nanofibers are produced from the polymer stream and collected on the conductive fibrous web.

The present invention also encompasses a process for producing a composite conductive fibrous material where the conductive fibrous web is grounded and an electrically charged polymer stream is attracted to the conductive web.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a simplified schematic representation of a process in accordance with one embodiment of the present invention;

FIG. 2 is a simplified schematic representation of a process in accordance with another embodiment of the present invention; and

FIG. 3 is a photomicrograph of a material produced by an embodiment of the present invention.

Repeated use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. It will be apparent to those skilled in the art that modifications and variations may be made in the present invention without departing from the scope or spirit of the invention. For instance, features illustrated or described as part of one embodiment may be used on another embodiment to yield a still further embodiment. It is intended that the present invention cover such modifications and variations.

Generally speaking, the present invention is broadly directed to a process for producing a composite conductive fibrous material that includes a conductive fibrous web upon which nanofibers have been spun. The term “nanofibers” generally refers to very small diameter fibers having an average diameter not greater than about 1000 nanometers (nm) and an aspect ratio (the ratio between length and width) greater than 50. Nanofibers are generally understood to have an average fiber diameter range of about 10 to about 1000 nm. In instances where particulates are present and heterogeneously distributed on the nanofibers, the average diameter of a nanofiber can be measured using known techniques (e.g., image analysis tools coupled with electron microscopy), but excluding the portions of a fiber that are substantially enlarged by the presence of added particles relative to the particle free portions of the fiber.

In general, many processes are capable of forming a conductive web suitable for use in the present invention. In particular, conductive fibrous webs such as textiles, which are generally considered to be flexible materials comprised of a network of natural or artificial fibers, are suitable for use in the present invention. Textiles are frequently categorized as woven materials or nonwoven materials. Generally, the term “woven web” is used to refer to a sheet or web of material formed by weaving, knitting, crocheting or knotting long fibers together. Fibers useful in woven materials include wool, silk, natural fibers such as hemp and jute, and mineral fibers such as those made from asbestos, basalt, glass and composite materials. Metal fibers and synthetic fibers such as polyester, acrylic, nylon and polyurethane fibers are also used in woven textiles.

The term “nonwoven web” generally refers to a sheet or web of material having a structure of individual fibers or threads which are interlaid, but not in an identifiable manner as in a woven fabric. Examples of suitable nonwoven webs include, but are not limited to, tissue webs, meltspun webs such as spunbond webs and meltblown webs, hydroentangled webs, bonded carded webs, and the like. The term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. The meltblown fibers are then carried by the high velocity gas stream and are deposited on a collecting surface to form a web of randomly dispersed meltblown fibers. The term “spunbond web” generally refers to a nonwoven web containing small diameter substantially continuous fibers. The fibers are formed by extruding a molten thermoplastic material from a plurality of fine, usually circular, capillaries of a spinneret with the diameter of the extruded fibers then being rapidly reduced as by, for example, eductive drawing and/or other well-known spunbonding mechanisms. Nonwoven webs are generally formed in a continuous process. The terms “machine direction” or “MD” typically refers to the direction in which a material is produced. In contrast, the term “cross-machine direction” or “CD” generally refers to the direction perpendicular to the machine direction.

The basis weight of nonwoven webs may generally vary, such as from about 0.1 grams per square meter (“gsm”) to about 120 gsm, in some embodiments from about 0.5 gsm to about 70 gsm, and in some embodiments, from about 1 gsm to about 35 gsm. Once formed, the nonwoven webs may be incorporated into laminates or may be used as a single ply.

As used herein, the term “conductive web” generally refers to a web which has an electrical surface resistivity that is less than 1×10⁶ ohm/square. The term “non-conductive” generally refers to a material which has an electrical surface resistivity that is equal to or greater than 1×10⁶ ohm/square. Electrical surface resistivity (designated as “ρₛ”) is a measure of a material's ability to conduct an electrical current. Electrical surface resistivity is determined by the following formula:

$${ρ}_{s} = \frac{U / L}{{I}_{s} / D}$$

where ρₛ is determined by the ratio of the DC voltage drop (designated as “U”) per unit length (designated as “L”) to the surface current (designated as “Iₛ”) per unit width (designated as “D”). The resulting resistance of the material is expressed in ohms per square.

Electrical surface resistivity is generally measured according to ASTM D 257-99. With respect to the present invention, electrical surface resistivity may be measured using a resistance meter which is available from Trek, Inc. (Medina, N.Y. or online at www. trekinc.com) and which is designated as Trek Model 152. A variety of probes may be utilized with the Trek Model 152 Surface Resistance Meter, including point-to-point probes, two-point probes or concentric ring probes. Specific instructions for measuring surface resistivity using the Trek Model 152 may be found in Trek Application Note Number 1005 entitled “Surface Resistivity and Surface Resistance Measurements Using a Concentric Ring Probe Technique”, also available from Trek, Inc. The electrode test voltage for the measurement probe may be selected as either 10V or 100V, and should be used on the 10V setting. Prior to testing, the samples are to be conditioned at a relative humidity of 50% and a temperature of 25° C. for eight hours.

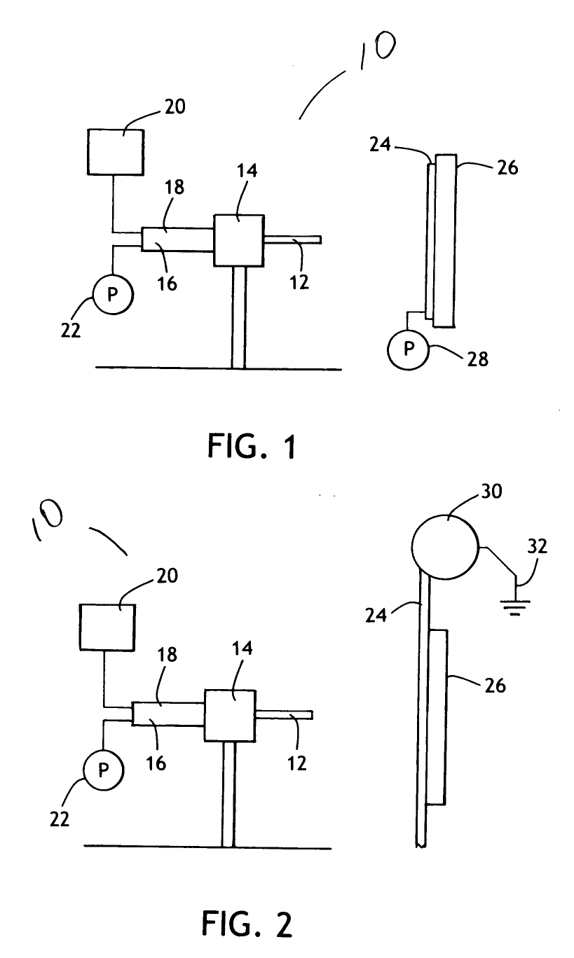

An exemplary electrospinning apparatus 10 for spinning a polymer solution is shown schematically in FIGS. 1 and 2. The electrospinning apparatus 10 includes a spinneret 12 which is held in position by a spinneret support 14. A polymer solution 16, which has been loaded into a syringe 18, is driven to the tip of the spinneret 12 by a pump 20 or other appropriate mechanism. The spinneret 12 and syringe 18 may be formed of metal, glass or other material which is suitable for use in an electrospinning apparatus.

A conductive fibrous web 24 may be positioned an appropriate distance from the tip of the spinneret 12. A non-conductive support 26 is positioned behind the conductive fibrous web 24 to hold the conductive fibrous web 24 in an appropriate position during spinning. Various materials may be utilized as the non-conductive support, including ceramic, cardboard, wood, etc. The conductive fibrous web 24 may, in selected embodiments, be secured to the non-conductive support 26 using releasable mechanical or adhesive fastening systems.

A voltage is established between the conductive fibrous web 24 and the polymer solution 16. In some embodiments, the conductive fibrous web may be grounded and the polymer solution may have a positive charge. In other embodiments, both the conductive fibrous web and the polymer solution may be positively charged, but with sufficient difference between the charges so that a voltage is established which causes the polymer solution to flow toward the conductive fibrous web. In still other embodiments, the polymer solution may be grounded and a positive charge may be applied to the conductive fibrous web. Such a configuration may assist in electrospinning materials which degrade or lose desirable properties when subjected to a positive electrical charge.

The voltage may be established in various ways, such as, for example and as shown in FIG. 1, power supplies 22 and 28 which may be electrically connected to the polymer solution 16 and the conductive fibrous web 24, respectively. Alternatively, the power supply 28 may be in electrical communication with the web 24 through a connector, device or other mechanism. The voltage established between the conductive fibrous web and the charged polymer stream may be in the range of 10-100 kV, although the use of voltages outside of this range may be appropriate. The voltage selected will depend upon the equipment configuration, polymer selection, as well as other variables. In some embodiments, voltages such as 10-40 kV or 50-80 kV may be suitable.

FIG. 2 illustrates a fibrous web 24 being unwound from or wound to a roll 30 which is electrically connected to a ground 32. The fibrous web 24 may be moved across the non-conductive support 26 using a conventional unwind/winding mechanism suitable for use with an electrospinning apparatus. A direct connection to ground may be attached to the conductive fibrous web 24.

The electrical and mechanical forces on the polymer solution 16 are sufficient to form a droplet at the tip of the spinneret 12 and draw an electrified liquid jet from the droplet. As the jet of polymer solution flows from the tip of the spinneret 12 to the conductive fibrous web 24, the jet of solution is stretched and the solvent in the polymer solution evaporates. The resulting fibers are deposited onto the conductive fibrous web 24.

A wire (not shown) within the syringe 18 may be used as an electrode to charge the polymer solution. The polymer solution may also be charged by charging the spinneret 12 or the syringe 18.

Other electrospinning systems, including systems having multiple spinnerets, may be utilized in accordance with the present invention. Numerous voltage sources may be provided to control the voltage applied to two or more groups of spinnerets.

A wide variety of polymer solutions are suited for use in the present invention. For example, such polymers include, but are not limited to, polyolefins, polyethers, polyacrylates, polyesters, polyamides, polyimides, polysiloxanes, polyphosphazines, vinyl homopolymers and copolymers, as well as naturally occurring polymers such cellulose and cellulose ester, natural gums and polysaccharides. Solvents that are known to be useful to dissolve the above polymers for solution electrospinning include, but are not limited to, alkanes, chloroform, ethyl acetate, tetrahydrofuran, dimethyl formamide, dimethyl acetamide, dimethyl sulfoxide, acetonitrile, acetic acid, formic acid, ethanol, propanol, and water.

Conductive fibers useful in fibrous webs include carbon fibers and metallic fibers. Suitable carbon fibers include fibers made entirely from carbon or fibers which contain only enough carbon so that the fibers are electrically conductive. Carbon fibers may be used that are formed from a polyacrylonitrile (PAN) polymer. Such carbon fibers are formed by heating, oxidizing, and carbonizing PAN polymer fibers. PAN-based carbon fibers are widely available from companies such as Toho Tenax America, Inc. of Rockwood, Tenn. Other raw materials used to make carbon fibers include rayon and petroleum pitch. Suitable conductive fibrous webs which include conductive fibers of carbon, such as SGL C25, are available from Technical Fibre Products Ltd. (Newburgh, N.Y.).

Suitable metallic fibers may include silver, copper and aluminum fibers and so forth. Such conductive fibers can have a variety of suitable lengths and diameters. Conductive polymeric fibers may be used and include fibers made from conductive polymers as well as polymeric fibers containing a conductive material or impregnated with a conductive material. Metal coated polymeric fibers and mixtures of these various conductive fibers may also be useful in the present invention.

The conductive fibers may be combined with other fibers such as natural or synthetic cellulosic fibers including, but not limited to cotton, abaca, flax, esparto grass, straw, jute hemp, or fibers obtained from deciduous and coniferous trees, including softwood fibers or hardwood fibers. Synthetic fibers such as rayon, polyolefin fibers, polyester fibers, polyvinyl alcohol fibers, bicomponent sheath-core fibers, multi-component binder fibers, and the like may also be combined with the conductive fibers. Recycled fibers may also be used in combination with the conductive and non-conductive fibers. The amount of conductive fibers within the web may be selected based on various design criteria, such as the type of fiber and the end use of the web.

The conductive web may contain a substantial amount of pulp fibers and can be made using a tissue making process. For instance, in one embodiment, the conductive fibers can be combined with pulp fibers and water to form an aqueous suspension of fibers that is then deposited onto a porous surface for forming a conductive tissue web. The conductivity of such a web can be controlled by selecting particular conductive fibers, locating the fibers at particular locations within the web and by controlling various other factors and variables. For example, the conductive fibers can be incorporated into a web that includes non-conductive fibers such that the web is electrically conductive in at least one zone. As such, the fibrous web can be made so that it is capable of carrying an electric current in the MD or CD direction, or in any suitable combination of directions. The conductivity of the fibrous web can vary depending upon the type of conductive fibers incorporated into the web, the amount of conductive fibers incorporated into the web, and the manner in which the conductive fibers are positioned, concentrated or oriented in the web.

A variety of binders including water and organic soluble polymers may be utilized to bind the various fibers into a web. Such binders are widely available and commonly known.

As described above, fibrous webs made in accordance with the present invention may be used in numerous applications, such as, for example, in protective garments, odor control applications, filtration, electrical applications such as sensors, drug delivery systems and other medical applications. Protective garments include, but are not limited to, absorbent articles such as diapers, training pants, adult incontinence and feminine care garments. Other protective garments include medical gowns, wound coverings, sterile wrap, face masks, surgical gloves, and so forth. The materials of the present invention are also useful for many other types of products, including, but not limited to, wipes, filtration media, absorbent pads, electrostatic webs, and so forth.

### EXAMPLES

In each of the following examples, a wet-laid carbon fiber nonwoven web was utilized as the conductive fibrous web 24. Specifically, a 17 gsm basis weight substrate designated as Optimat® Grade 20304A was obtained from Technical Fibre Products Ltd. (Newburgh, N.Y.). The Optimat® Grade 20304A is formed of carbon fibers having lengths of from 6 mm to 12 mm with an average diameter of seven microns. The carbon fibers are bonded with an insoluble cross-linked polyester binder.

In each example, a ground wire was attached to the carbon nonwoven web to effectively ground the carbon nonwoven web. Each conductive carbon nonwoven web was held in a stationary position by a non-conductive cardboard support. The distance between the tip of the spinneret and the conductive nonwoven was between 10 and 20 cm.

An electrospinning apparatus as schematically shown in FIG. 1 was utilized to apply nanofibers to a conductive nonwoven web. In all examples, a high voltage charge of between 10 and 25 kV was applied to the polymer solution to initiate electrospinning.

In each example, a stable droplet was maintained at the tip of the spinneret by pressure. In Examples 1, 2 and 3, a syringe pump was utilized to apply pressure to the polymer solution to maintain a stable droplet at the end of a blunt-tipped 20 gauge needle which was positioned within and supported by an aluminum block. In Examples 4 and 5, a hydrostatic pressure system was utilized to maintain an appropriate amount of polymer solution at the tip of the needle. The hydrostatic pressure system differed from the syringe pump in that it provided improved control over the electrospinning process, reduced material waste and provided increased safety when operating the apparatus.

In Example 1, a solution of deionized water, MUA and DMF was prepared. MU-4 is an ion-responsive cationic acrylic copolymer that is available in a 27% by weight solution in water from Bostik, Inc. (Wauwatosu, Wis.) as product #LX-7170-03. The reported relative molar mass (Mᵣ) of MU-4 is about 250,000. Reagent grade N,N-dimethylformamide (DMF) was purchased from Aldrich Chemical Co., Inc. (Milwaukee, Wis.), which was added to the MU-4 solution such that the DMF comprised 16% by weight of the total polymer solution. A voltage between 10 and 25 kV was applied to the aluminum block as the syringe pump moved the polymer solution to the tip of the needle.

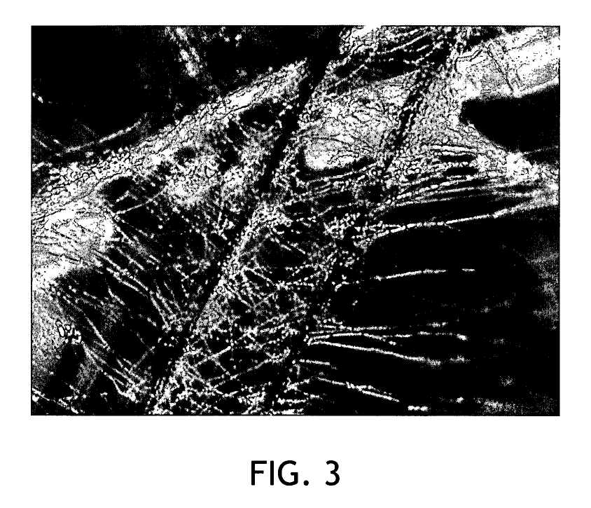

As seen in FIG. 3, the nanofibers produced show good distribution and uniformity. Relative fiber sizes of the polymer were compared to the much smaller fiber sizes of the conductive carbon nonwoven web. When compared to the larger carbon fiber webs, the smaller electrospun fibers appeared to range from sub-micron diameters to a few microns in diameter.

In Example 2, AQ 38S polymer pellets were added to DMF so that the resulting polymer solution constituted 42% by weight DMF. AQ 38S is a sulfopolyester available from the Eastman Chemical Co. (Kingsport, Tennessee) having a Mᵣ of about 8,000. Dissolution was achieved by mechanically agitating the solution. The set-up of Example 1 was utilized for Examples 2 and 3. In Example 3, polydimethylaminoethyl methacrylate (PDMAEMA) was obtained from Polysciences, Inc. (Warrington, Pa.) as a 20% by weight solution in tert-butanol. The relative molar mass of the PDMAEMA is about 50,000.

In Examples 4 and 5, the polymer solution was contained in a glass pipette that was connected to a nylon tee. A tungsten wire was electrically connected to a high voltage power supply and fed horizontally through the tee to charge the solution. All connections were airtight to prevent pressure leakage. Needle valves and a flow meter were attached to the remaining outlet on the nylon tee, which permitted precise pressure to be applied to the charged solution within the pipette.

In Example 4, polyhydroxyethyl methacrylate (PHEMA) obtained from Aldrich Chemical Co., Inc (Milwaukee, Wis.) having a Mᵣ of about 300,000 was added to DMF so that the resulting polymer solution constituted 30% by weight DMF. Dissolution was achieved by mechanically agitating the solution. In Example 5, polyethylene oxide (PEO) was obtained from Polysciences, Inc. (Warrington, Pa.) having a Mᵣ of 300,000 and added to PHMB (polyhexamethylene biguanide) in a ratio of 10.0 to 0.9. PHMB was purchased form Arch Chemicals, Norwalk, Conn. as Cosmocil® CQ. Deionized water was added to the PEO/PHMB such that the final polymer solution constituted 6% by weight water.

The materials formed in each example showed good distribution and uniformity of the nanofibers on the conductive nonwoven web. Hence, materials formed by the process of the present invention would be suitable for use a wide variety of applications including, but not limited to, commercial, medical and personal applications such as, for example, protective garments, devices and components of devices and filtration of gasses and liquids.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A process for producing a composite conductive fibrous material comprising the steps of:
providing a conductive fibrous web with a first potential;
supporting the conductive fibrous web with a nonconductive support member;
providing a polymer stream with a second potential which is different from the first potential so that the polymer stream is attracted to the conductive fibrous web;
producing nanofibers from the polymer stream; and
collecting the nanofibers on the conductive fibrous web.

2. The process of claim 1 wherein the first potential is zero and the second potential is a positive charge.

3. The process of claim 2 wherein the difference between the first potential and the second potential creates a voltage greater than 10 kV.

4. The process of claim 3 wherein the difference between the first potential and the second potential creates a voltage greater than 40 kV.

5. The process of claim 1 wherein the second potential is zero and the first potential is a positive charge.

6. The process of claim 5 wherein the difference between the first potential and the second potential creates a voltage greater than 10 kV.

7. The process of claim 6 wherein the difference between the first potential and the second potential creates a voltage greater than 40 kV.

8. The process of claim 1 wherein the polymer stream is formed from polyolefins, polyethers, polyacrylates, polyesters, polyamides, polyimides, polysiloxanes, polyphosphazines, vinyl homopolymers and copolymers, naturally occurring polymers such cellulose, cellulose ester, natural gums and polysaccharides, or mixtures thereof.

9. The process of claim 1 wherein the conductive fibrous web includes conductive fibers comprising carbon fibers, metallic fibers, conductive polymeric fibers, metal coated fibers, or mixtures thereof.

10. The process of claim 9 wherein the conductive fibrous web includes conductive carbon fibers having an average length of from about 1 mm to about 12 mm.

11. The process of claim 9 wherein the conductive fibrous web includes carbon fibers that are formed from a polyacrylonitrile.

12. The process of claim 1 wherein the conductive fibrous web is a nonwoven web.

13. The process of claim 1 wherein the conductive fibrous web is a woven web.

14. A process for producing a composite conductive fibrous material comprising the steps of:
providing a conductive fibrous web;
supporting the conductive fibrous web with a nonconductive support member;
providing a polymer stream;
establishing a voltage between the conductive fibrous web and the polymer stream so that the polymer stream is attracted to the conductive fibrous web;
producing nanofibers from the polymer stream; and
collecting the nanofibers on the conductive fibrous web.

15. The process of claim 14 wherein the step of establishing a voltage between the conductive fibrous web and the polymer stream creates a voltage greater than 10 kV.

16. The process of claim 15 wherein the step of establishing a voltage between the conductive fibrous web and the polymer stream creates a voltage greater than 40 kV.

17. A filter including the conductive composite made according to the process of claim 1.

18. A protective garment including the conductive composite made according to the process of claim 1.

19. A process for producing a composite conductive fibrous material comprising the steps of:
providing a conductive fibrous web comprising carbon fibers;
supporting the conductive fibrous web with a non-conductive support;
providing an electrically charged polymer stream;
grounding the conductive fibrous nonwoven web so that the charged polymer stream is attracted to the conductive fibrous web;
producing nanofibers from the charged polymer stream; and
collecting the nanofibers on the grounded conductive fibrous web.
